(19) United States
(12) Patent Application Publication
(10) Pub. No.: US 2020/0181964 A1
(43) Pub. Date: Jun. 11, 2020

(54) SPRING HINGE BASE STRUCTURE

(71) Applicants: Chun-Yu Wu, Lu Kang Chen (TW); JYI HSING ENTERPRISE CO., LTD., Lu Kang Chen (TW)

(72) Inventor: Chun-Yu Wu, Lu Kang Chen (TW)

(21) Appl. No.: 16/212,685

(22) Filed: Dec. 7, 2018

(51) Int. Cl. E05F 1/12; E05D 5/14

(52) U.S. Cl. CPC E05F 1/1215; E05Y 2900/132; E05D 5/14

(57) ABSTRACT

A spring hinge base structure includes: a first fixing leaf, having a tube; a plurality of locking units, each having a cover and engagement member, each cover respectively configured on two ends of the tube, a center of each cover configured with a first through hole, one end thereof a groove, the first through hole positioned inside the groove, each engagement member in combination with an inside of the groove and configured with an engagement groove; an elastic element, two ends thereof respectively engaged with each engagement groove; a second fixing leaf, two ends of one side thereof respectively projected with a blocking portion, each blocking portion configured with a second through hole and pressed against an outer side of the corresponding cover, allowing each second through hole to be in communication with the corresponding first through hole; and a bolt, passed through the first and second through holes.

### (a) TECHNICAL FIELD OF THE INVENTION

The present invention relates to a spring hinge, and more particularly to a spring hinge base, capable of bearing heavy door leaf opening and closing movements.

### (b) DESCRIPTION OF THE PRIOR ART

A conventional spring hinge is a simple mechanical device that uses an elastic element such as a spring or elastic piece to generate a torsional force to drive a door leaf to open and close, generally used to cause the door leaf to be closed automatically or to keep the door leaf open. In terms of general spring hinge action, it includes one-way movement of the door leaf and two-way movement of the door leaf Upon use, one leaf of the spring hinge is fixed to a door frame and another leaf thereof the door leaf, and the door leaf can be closed again or kept open after the movement thereof by means of the torsional physical movement generated from the elastic element such as the spring or elastic piece fixed in a hinge tube.

Such kinds of spring hinges are applied to public building fire doors, indoor kitchens, living room compartment doors, outdoor fence doors, etc., and the base for the provision of the torsional movement of the hinge spring or elastic piece is generally purely made of a single material such as copper, aluminum, iron, zinc alloy and plastic fiber by means of die casting, turning, injection, etc. However, the elastic elements such as the clamping springs or elastic piece of the base (including fixation seat and adjustment seat) made of copper, aluminum, iron, zinc alloy and plastic fiber with soft material and low density are repeatedly broken or severely worn and torn, further causing the failure of the torsion or the severe weakening of the torsion of the spring or elastic piece of the spring hinge, because they have no sufficient strength to bear the overlarge pressure generated from the high-frequency movement of a thick and heavy door leaf.

The spring hinge elastic element base (including fixation seat and adjustment seat) made of copper, aluminum, iron, zinc alloy and plastic fiber cannot bear the high torsional movement of the elastic elements, resulting in the shortened operation life of the spring hinge.

### SUMMARY OF THE INVENTION

To overcome the defects mentioned above, the present invention is proposed.

The present invention proposes a spring hinge base structure, including: a first fixing leaf, one side thereof having a tube; a plurality of locking units, each having a cover and an engagement member, each cover respectively configured on two ends of the tube, a center of each cover configured with a first through hole, one end of each cover a groove, the first through hole positioned inside the groove, each engagement member in combination with an inside of the groove and configured with an engagement groove; an elastic element, two ends thereof respectively engaged with each engagement groove; a second fixing leaf, upper and lower ends of one side thereof respectively projected with a blocking portion, each blocking portion configured with a second through hole, each blocking portion pressed against an outer side of the corresponding cover, allowing each second through hole to be in communication with the corresponding first through hole; and a bolt, passed through each first through hole and each second through hole.

### BRIEF DESCRIPTION OF THE DRAWINGS

FIG. 1 is a perspective view of the present invention; and

FIG. 2 is an exploded view of the present invention.

### DETAILED DESCRIPTION OF THE PREFERRED EMBODIMENTS

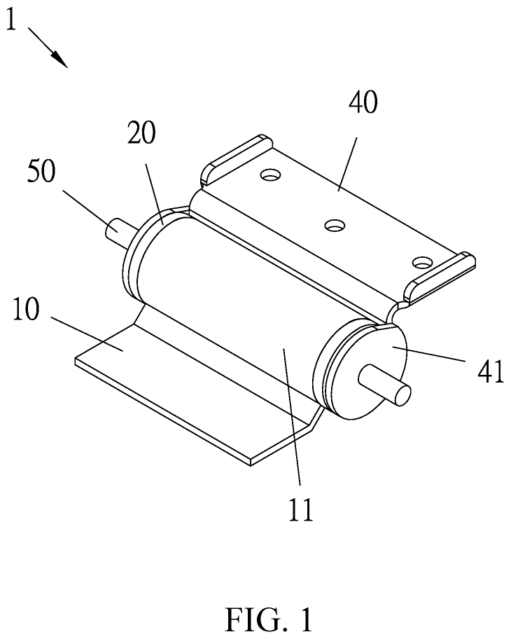

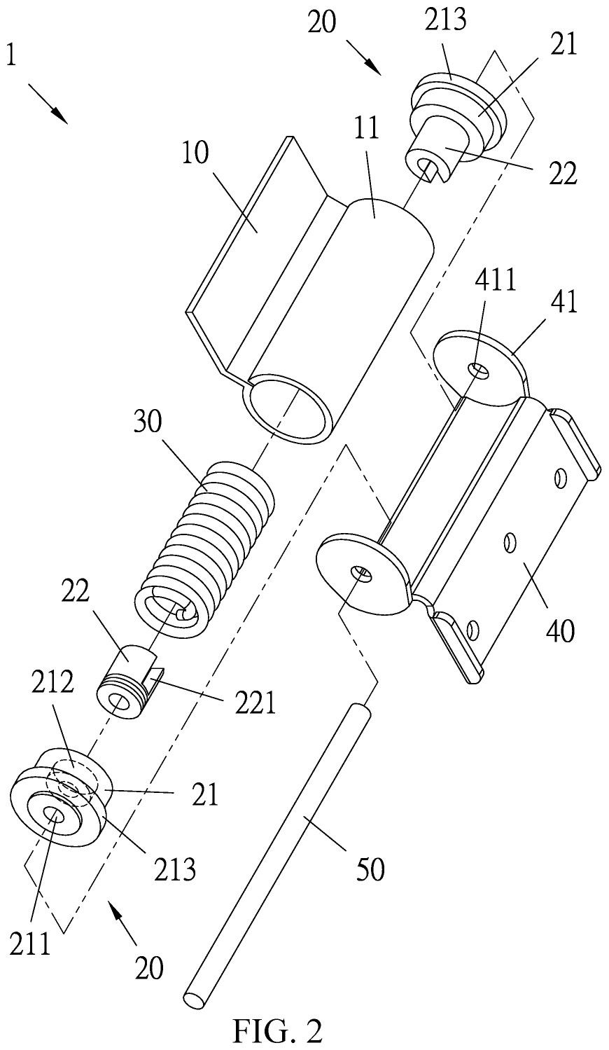

Referring to FIGS. 1 and 2, a spring hinge base structure of the present invention includes a first fixing leaf 10, a plurality of locking units 20, an elastic element 30 and a second fixing leaf 40.

The first fixing leaf 10 has a tube 11 on one side thereof.

Each locking element 20 has a cover 21 and an engagement members 22, each cover 21 is respectively configured on the two ends of the tube 11; the center of the cover 21 is configured with a first through hole 211; one end surface of each cover 21 is configured with a groove 212 where the first through hole 211 is positioned inside. Furthermore, the engagement member 22 is in combination with the inside of the groove 212, and the engagement member 22 is configured with an engagement groove 221.

The top of cover 21 is annularly configured with a flange 213 respectively in contact with the two ends of the tube 11. Furthermore, the inner wall of the groove 212 of the cover 21 is configured with internal threads, and one end of the engagement member 22 external threads, thereby allowing the engagement member 22 to be engagement with the groove 212, but the present invention is not so limited, the engagement may also be welding, positioning hole riveting, bolt or buckle fastening.

The cover 21 may be made of copper, aluminum, zinc alloy or plastic fiber, and the engagement member iron.

The two ends of the elastic element 30 are respectively engaged with the engagement groove 221, where the elastic element 30 may be a spring or elastic piece.

The upper and lower sides of one side of the second fixing leaf 40 are respectively projected with a blocking portion 41 on which a second through hole 411 is configured; each blocking portion 41 is pressed against the outer side of the cover 21, allowing each second through hole 411 to be in communication with the corresponding first through hole 211.

A bolt 50 is passed through each first through hole 211 and each second through hole 411.

To sum up, the spring hinge base structure of the present invention can have a higher bearing performance and strength against high-pressure torsional movement because of the combination structure of the cover 21 with engagement member 22 and the use of different materials.

I claim:

1. A spring hinge base structure, comprising:
a first fixing leaf, one side thereof having a tube;
a plurality of locking units, each having a cover and an engagement member, said cover respectively configured on two ends of said tube, a center of each said cover configured with a first through hole, one end of each said cover a groove, said first through hole positioned inside said groove, each said engagement member in combination with an inside of said groove and configured with an engagement groove;
an elastic element, two ends thereof respectively engaged with said engagement groove;
a second fixing leaf, upper and lower ends of one side thereof respectively projected with a blocking portion, each said blocking portion configured with a second through hole, each said blocking portion pressed against an outer side of said corresponding cover, allowing each said second through hole to correspond to and be in communication with said through first through hole; and
a bolt, passed through each said first through hole and each said second through hole.

2. The structure according to claim 1, wherein an inner wall of said groove of said cover is configured with internal threads, and one end of each said engagement member external threads, thereby allowing each said engagement member to be in engagement with said corresponding groove.

3. The structure according to claim 1, wherein a top portion of each said cover is annularly configured with a flange, and each said flange is respectively in contact with two ends of said tube.

4. The structure according to claim 2, wherein said cover is made of copper, aluminum, zinc alloy or plastic fiber, and said engagement member heat-treated steel.
